(19) United States
(12) Patent Application Publication
(10) Pub. No.: US 2011/0005089 A1
(43) Pub. Date: Jan. 13, 2011

(54) COVER FOR SHAVING CARTRIDGES

(76) Inventors: Richard Kevin Sennett, Abington, MA (US); Kelly Daniel Bridges, Quincy, MA (US); Douglas Robert Kohring, Chelmsford, MA (US); Carmen Gallo, Lynn, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/500,666

(22) Filed: Jul. 10, 2009

(51) Int. Cl. B26B 21/40

(52) U.S. Cl. 30/539

(57) ABSTRACT

A cartridge cover assembly having a reversible cover and a shaving cartridge with a first and second positions. The cartridge has at least one blade, a top surface having a front end portion with a guard member and a rear end portion with a lubricating strip. The cover has a front wall with a first retention member, a back wall with a second retention member, a bottom wall, and a pair of side walls defining a pocket dimensioned to nestingly receive the cartridge. The rear end portion of the cartridge is engaged between the first retention member and the front wall in the first position. The rear end portion of the cartridge is engaged between the second retention member and the back wall in the second position. The top surface of the cartridge is spaced apart from the bottom wall of the cover in the first and second positions.

### FIELD OF THE INVENTION

The present invention relates to a cover for use with shaving cartridges to protect the cartridge during periods of non-use.

### BACKGROUND OF THE INVENTION

In general, shaving razors of the wet shave type include a cartridge or blade unit with at least one blade with a cutting edge which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled (i.e., disposable razor). Various types of protective covers have been utilized with commercially available razor cartridges that are either detachably or permanently mounted to a handle. These covers may serve several purposes. First, the cover protects the razor cartridge and the blade edges during the different stages of shipping and retailing from forces which may damage the blade edges. Secondly, the cover also protects a user from unintentionally encountering the razor's sharp blade or blades when the razor is not in use. Furthermore, the cover may serve as a storage unit for the razor cartridge between shaves. The covers which are currently available typically require a removal force in the direction of separation (i.e., the cover is either pulled or pushed directly off of the razor in the direction of the applied force). For some consumers, especially consumers that have always used a double edge razor without any protective cover, the removal of the cover is not intuitive. For example, the consumer may unintentionally remove the razor cartridge from the handle when removing the cover, which may damage the attachment mechanism of the shaving razor. Placing the cover back on the razor cartridge can also be problematic for such consumers. For example, if the consumer places the cover on the cartridge incorrectly, the cover may damage the cartridge or the cover may get stuck to the cartridge, making subsequent removal of the cover difficult.

Many commercially available razor cartridges have a lubricating strip positioned behind the blades. The lubricating strip absorbs water and leaches out one or more lubrication aids during shaving to reduce the frictional drag of the blades against the skin. After shaving the user may store the cartridge in the cover. If the cartridge is placed incorrectly within the cover, the lubricating strip may contact the cover, which may prevent proper drying of the lubricating strip or potentially damage the lubricating strip. Furthermore, if the lubricating strip is not allowed to properly dry, it may continue to leach out water and shaving aid during storage. The water and shaving aid may leach onto the blades or the guard of the cartridge. The consumer may intuitively wipe the blade clean with a towel, but this may damage the edges of the blades. If water and shaving aid is allowed to dry on the blades, the blade edges may corrode faster and/or require extensive rinsing to remove the dried shaving aid prior to the next shave.

### SUMMARY OF THE INVENTION

In one aspect, the invention features, in general, a shaving cartridge cover assembly having a reversible cover and a shaving cartridge with a first and second positions. The shaving cartridge has at least one blade, a top surface having a front end portion with a guard member and a rear end portion with a lubricating strip. The reversible cover has a front wall with a first retention member, a back wall with a second retention member, a bottom wall, and a pair of side walls defining a pocket dimensioned to nestingly receive the cartridge. The rear end portion of the shaving cartridge is engaged between the first retention member and the front wall in the first position. The rear end portion of the shaving cartridge is engaged between the second retention member and the back wall in the second position. The top surface of the shaving cartridge is spaced apart from the bottom wall of the cover in the first and second positions.

In another aspect, the invention features, in general, a cover for a razor cartridge having a front wall with a first retention member, a back wall with a second retention member, a bottom wall and a pair of side walls defining a pocket dimensioned to nestingly receive a razor cartridge. A flange is transversely joined to the front wall, the back wall, and the pair of side walls. The flange has an enlarged tab member associated with the back wall. If desired, the flange may optionally include a removal indicia.

### BRIEF DESCRIPTION OF THE DRAWINGS

FIG. 1 is a perspective bottom view of one possible embodiment of a shaving cartridge cover assembly.

FIG. 2 is a perspective side view of a reversible cover and a shaving cartridge of the shaving cartridge cover assembly of FIG. 1.

FIG. 3A is a cross section view of the shaving cartridge cover assembly in a first position, taken generally along the line 3-3 of FIG. 1.

FIG. 3B is a cross section view of the shaving cartridge cover assembly in a second position, taken generally along the line 3-3 of FIG. 1.

FIG. 4 is a bottom view of an alternative embodiment of a cover for the shaving cartridge of FIG. 2.

### DETAILED DESCRIPTION OF THE INVENTION

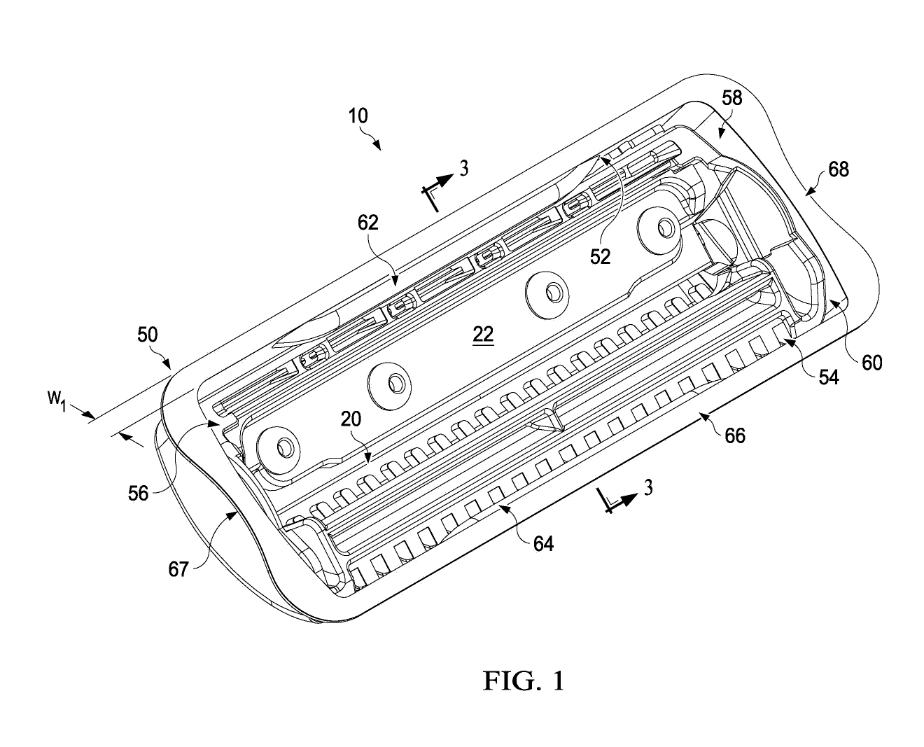

Referring to FIG. 1, one possible embodiment of the present invention is shown illustrating a shaving cartridge cover assembly 10. The shaving cartridge cover assembly 10 may include a shaving razor cartridge 20 nestingly received within a reversible cover 50. In certain embodiments, the reversible cover 50 may be injection molded or thermoformed from a polymer material, including but not limited to, poly vinyl chloride (PVC), polyethylene terephthalate (PET), high density polyethylene (HDPE), and low density polyethylene (LDPE), polypropylene (PP), or any combination thereof. The reversible cover 50 may be placed over the shaving razor cartridge 20 with or without a handle (not shown) mounted to the shaving razor cartridge 20. The cartridge cover assembly 10 may allow a bottom surface 22 of the shaving razor cartridge 20 exposed for easy rinsing and mounting of the shaving cartridge 20 to a handle.

The reversible cover 50 may have a front wall 52, a back wall 54, and a pair of side walls 56 and 58 that define a pocket 60 dimensioned to nestingly receive the shaving razor cartridge 20. The front wall 52 and/or the back wall 54 may have one or more retention members 62 and 64 to secure the shaving razor cartridge 20 within the pocket 60. Although two retention members are shown, more or less retention members may be used. For example, only the first retention member 62 on the front wall 62 may be needed to secure the shaving cartridge 20 within the reversible protectable cover 50. In certain embodiments, the retention members 62 and 64 may be elongated protrusions that extend along the respective front and back walls 52 and 54. The retention members 62 and 64 may be continuous or segmented and may extend along about 25%, 35%, or 45% to about 75%, 85%, or 95% of the length of the front or back walls 52 and 54 (i.e., distance between the pair of side walls 56 and 58). In certain embodiments, the length of the front and back walls 52 and 54 may be about 20 mm, 25 mm, or 30 mm to about 60 mm, 70 mm, or 80 mm.

A flange 66 may define a perimeter of the reversible cover 50. The flange 66 may be joined transversely to the front wall 52, the back wall 54, and the pair of side walls 56 and 58. The flange 66 may enhance the rigidity of the reversible cover 50 to increase the force required to remove the reversible cover 50 from the shaving razor cartridge 20 to prevent unintentional removal of the reversible cover 50 from the shaving razor cartridge 20. In certain embodiments, the flange 66 may have a width w₁ that extends out from the front wall 52, the back wall 54, and the pair of side walls 56 and 58 by about 0.5 mm, 0.75 mm, or 1 mm to about 2.0 mm, 2.5 mm, or 3 mm. The width w₁ of the flange 66 may vary around the perimeter of the reversible protectable cover 50, for example, w₁ may be greater at the front wall 52 than the back wall 54 (or the pair of side walls 56 and 58). The flange 66 may have a pair of opposing curved (e.g., concave) portions 67 and 68 to provide a contoured area for a user to grip and remove the reversible cover 50 from the shaving razor cartridge 20. In certain embodiments, the opposing curved portions 67 and 68 may be associated with the pair of side walls 56 and 58 to ensure the user grips the reversible cover 50 generally transverse to the retention members 62 and 64. For example, the user may inadvertently apply force to the retention members 62 and 64 if the front wall 52 and the back wall 54 are gripped during removal. The force applied to the retention members 62 and 64 may make the reversible cover 50 more difficult to remove, which may result in the shaving razor cartridge 20 becoming unintentionally detached from the handle (not shown).

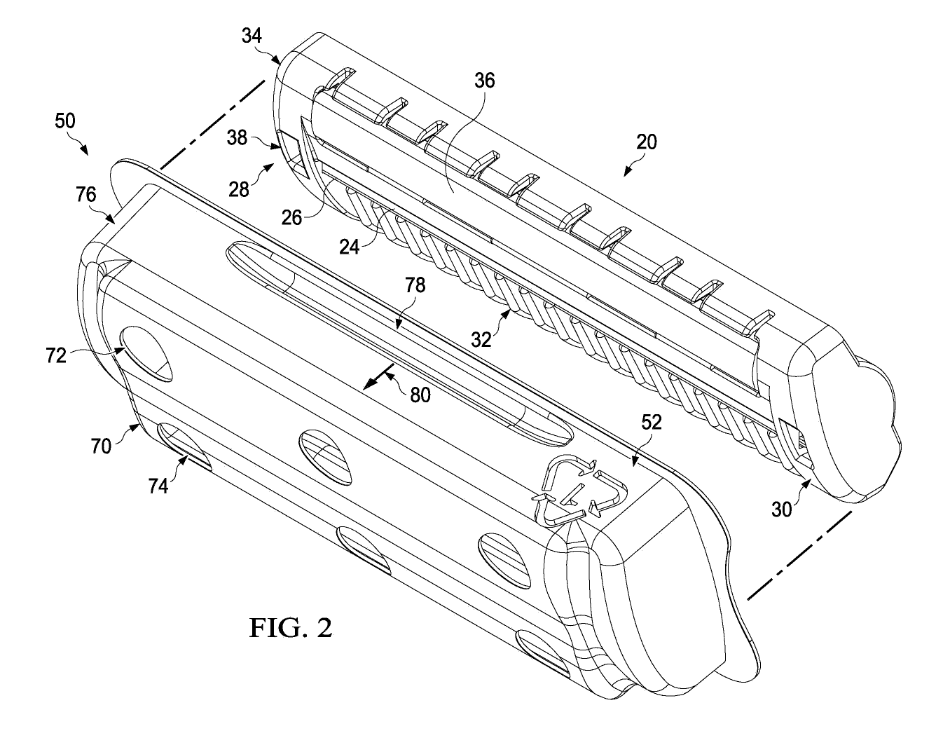

FIG. 2 illustrates a perspective side view of the reversible cover 50 removed from the shaving razor cartridge 20. The shaving razor cartridge 20 may have least one blade 24 mounted to a housing 38 wherein the blade 24 has an exposed cutting edge 26. The housing may have a top surface 28, a front end portion 30 with a guard member 32 and a rear end portion 34 with a lubricating strip 36. The lubricating strip 36 may be joined to the housing 38 with adhesives, mechanical fasteners (e.g., snap fits or press fits), or the lubricating strip 36 may be molded to or integral with the housing 38. The lubricating strip 36 may be molded or extruded from the same material as the housing 38 or may be molded or extruded from a more lubricious material that has a water-leachable shaving aid composition to provide increase comfort during shaving, such as a water-soluble polymer. Suitable skin lubricating water-soluble polymers may include polyethylene oxide, polyvinyl pyrrolidone, polyacrylamide, hydroxypropyl cellulose, polyvinyl imidazoline, and polyhydroxyethylmethacrylate. Other water-soluble polymers may include the polyethylene oxides generally known as POLYOX (available from Union Carbide Corporation) or ALKOX (available from Meisei Chemical Works, Kyota, Japan). These polyethylene oxides may have molecular weights of about 100,000 to 6 million, for example, about 300,000 to 5 million. The polyethylene oxide may comprises a blend of about 40 to 80% of polyethylene oxide having an average molecular weight of about 5 million (e.g., POLYOX COAGULANT) and about 60 to 20% of polyethylene oxide having an average molecular weight of about 300,000 (e.g., POLYOX WSR-N-750). The polyethylene oxide blend may also contain up to about 10% by weight of a low molecular weight (i.e., MW<10,000) polyethylene glycol such as PEG-100.

The lubricating strip 36 may also optionally include an inclusion complex of a skin-soothing agent with a cylcodextrin, low molecular weight water-soluble release enhancing agents such as polyethylene glycol (e.g., 1-10% by weight), water-swellable release enhancing agents such as cross-linked polyacrylics (e.g., 2-7% by weight), colorants, antioxidants, preservatives, microbicidal agents, beard softeners, astringents, depilatories, medicinal agents, conditioning agents, moisturizers, cooling agents, etc.

The reversible cover 50 may protect the lubricating strip 36 and the blade 24 from being damaged and also facilitate proper drying of the shaving razor cartridge 20 during storage between shaves. The reversible cover 50 may be placed over the shaving razor cartridge 20 such that the top surface 28 of the shaving razor cartridge 20 faces a bottom wall 70 of the reversible cover 50. The bottom wall 70 of the reversible cover 50 may have a first and second set of drainage openings 72 and 74 to facilitate drying of the shaving razor cartridge 20. As will be explained in greater detail below, the arrangement of the shaving razor cartridge 20 and the reversible cover 50 may facilitate rinsing of the shaving razor cartridge 20 without removing the reversible cover 50. For example, the first and second set of drainage openings 72 and 74 may be arranged in parallel rows to provide optimum drainage of the shaving razor cartridge 20 in a plurality of positions within the reversible cover 50.

The front wall 52 of reversible cover 50 may have an outer surface 76 with one or more retention member indicators 78, such as an elongated recess, to specify to a consumer a location of the respective retention member 62, which may be hidden from view. In certain embodiments, the retention member indicator 78 may be a negative impression of the retention member 62. Although not shown in FIG. 2, is understood that the back wall 54 may also have an outer surface with one or more retention member indicators to specify to a consumer a location of the respective retention member 64, which may also be hidden from view. The outer surface 76 of the reversible cover 50 may also include a removal indicator 80 to specify to the consumer the direction to apply force for removing the reversible cover 50 (e.g., an arrow).

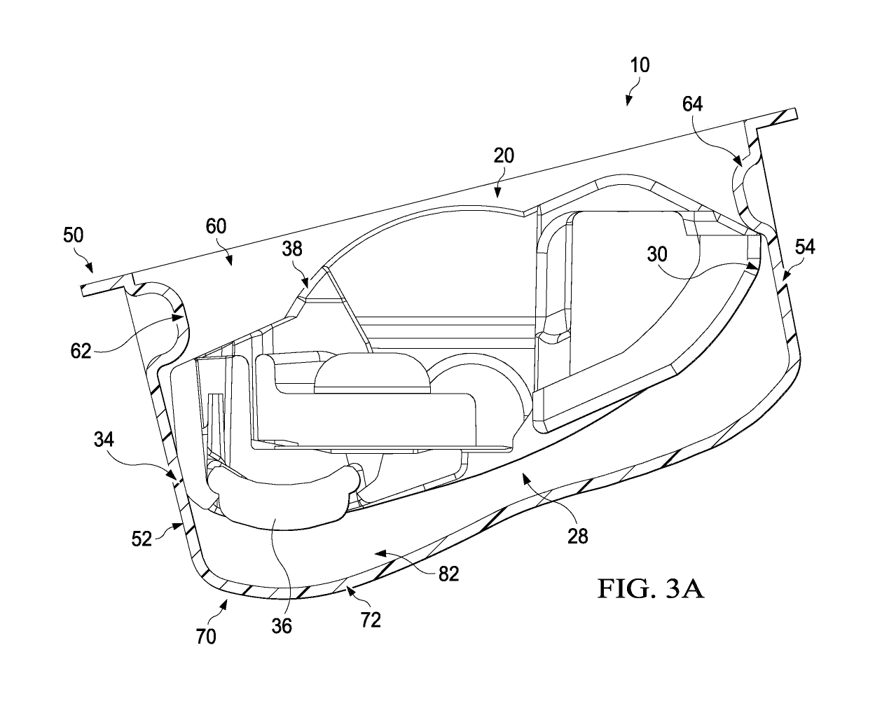

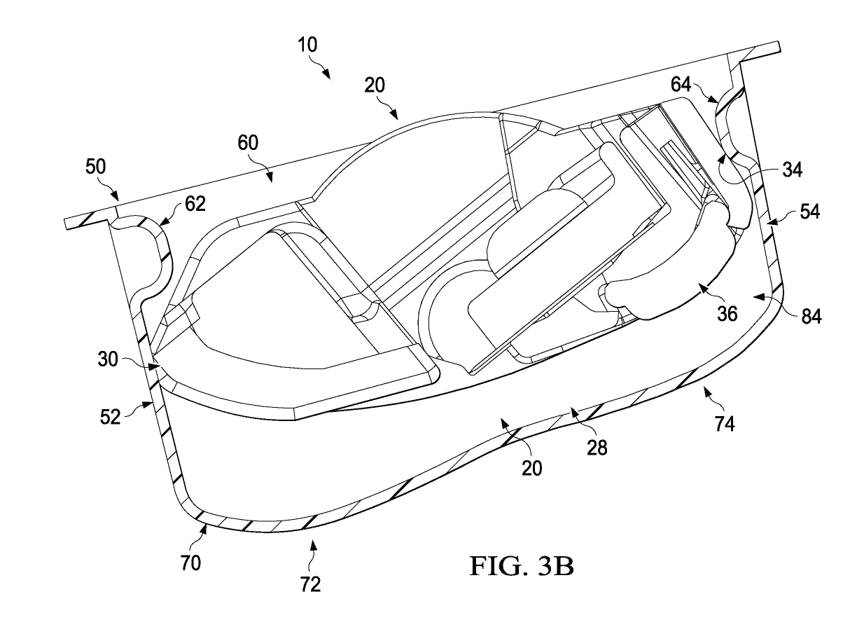

Referring to FIG. 3A, a cross section view of the cartridge cover assembly 10 is shown in a first position, taken generally along the line 3-3 of FIG. 1. In the first position the shaving razor cartridge 20 may be placed within the pocket 60 of the reversible cover 50 with the top surface 28 of the shaving razor cartridge 20 facing the bottom wall 70 of the reversible cover 50. The positioning of the top surface 28 of the shaving razor cartridge 20 adjacent to the bottom wall 70 may isolate the lubricating strip 36 to protect the lubricating strip 36 from dirt, dust, or debris which may be present during storage or transport of the cartridge cover assembly 10. The lubricating strip 36 may be surrounded on one side by the front wall 52 and on another side by the bottom wall 70 of the reversible cover 50. The shaving cartridge 20 may be placed in the reversible cover 50 in first position such that the rear end portion 34 of the shaving razor cartridge 20 is engaged between the first retention member 62 and the front wall 52 of the reversible cover 50. In addition, the shaving razor cartridge 20 may also be secured by the front end portion 30 of the cartridge being engaged between the second retention member 64 and the back wall 54 of the reversible cover 50. A consumer may remove the reversible cover 50 by grapping the pair of opposing curved portions 67 and 68 and pulling the reversible cover 50 away from the shaving cartridge 20. The reversible cover 50 may flex to permit the retention members 62 and 64 to disengage the shaving cartridge 20.

The shaving razor cartridge 20 may be positioned within the reversible cover 50 to provide an open space 82 between the top surface 28 of the shaving razor cartridge 20 and the bottom wall 70 of the reversible cover 50. In certain embodiments, the top surface 28 (e.g., the lubricating strip 36 or guard member 32) of the shaving razor cartridge 20 may spaced apart (i.e., open space 82) from the bottom wall 70 of the reversible cover 50 by about Xmm, Xmm, or Xmm to about Ymm, Ymm, or Ymm The open space 82 and the first and second set of drainage openings 72 and 74 may allow for optimum drainage and ventilation of the shaving razor cartridge 20. The lubricating strip 36 may also be located directly above the first set of drainage openings 72 to provide direct drainage and improved ventilation of the lubrication strip 36 after shaving.

Referring to FIG. 3B, a cross section view of the cartridge cover assembly 10 is shown in a second position. The reversible cover 50 may be reversible such that the reversible cover 50 nestingly receives the shaving razor cartridge 20 in more than one orientation with top surface 28 of the shaving razor cartridge 20 facing the bottom wall 70 of the reversible cover 50. The reversible function may facilitate fast and simple placement of the shaving razor cartridge 20 within the pocket 60. The plurality of positions also may also reduce the possibility the lubrication strip 36 is damaged by improper placement of the reversible cover 50 over the shaving razor cartridge 20. In addition to the first position described above, the shaving razor cartridge 20 may be placed within the pocket 60 of the reversible cover 50 in the second position wherein the rear end portion 34 of the shaving razor cartridge 20 is secured between the second retention member 64 and the back wall 54 of the reversible cover 50. Furthermore, the front end portion 30 of the cartridge may be secured between the first retention member 62 and the front wall 52 of the reversible cover 50. The second position may also allow for the same drainage and ventilation of the shaving razor cartridge 20 as the first position. For example, the shaving razor cartridge 20 may be positioned within the reversible cover 50 wherein a second open space 84 is provided between the top surface 28 and the bottom wall 70 of the reversible cover 50. In certain embodiments, the top surface 28 (e.g., the lubricating strip 36 or guard member 32) may be spaced apart (i.e., the second open space 84) from the bottom wall 70 of the reversible cover 50 by about 0.5 mm, 0.75 mm, or 1 mm to about 1.5 mm, 2 mm, or 3 mm The lubricating strip 36 may also be located directly above the second set of drainage openings 74 to provide direct drainage and improved ventilation of the lubrication strip 36 after shaving.

The arrangement of the shaving razor cartridge 20 (e.g., the blade 24 and the guard member 32) and the reversible cover 50 may facilitate rinsing of the shaving razor cartridge 20 without removing the reversible cover 50. For example, the reversible cover 50 may be open such that both the top surface 28 and the bottom surface 22 of the shaving razor cartridge 20 can be exposed directly to water while the shaving razor cartridge 20 is still received within the reversible cover 50. The pocket 60 of reversible cover 50 may be open to expose the bottom surface 22 of the shaving razor cartridge 20 to water during rinsing and the first and second set of drainage openings 72 and 74 may expose the top surface 28 of the shaving razor cartridge 20 to water during rinsing.

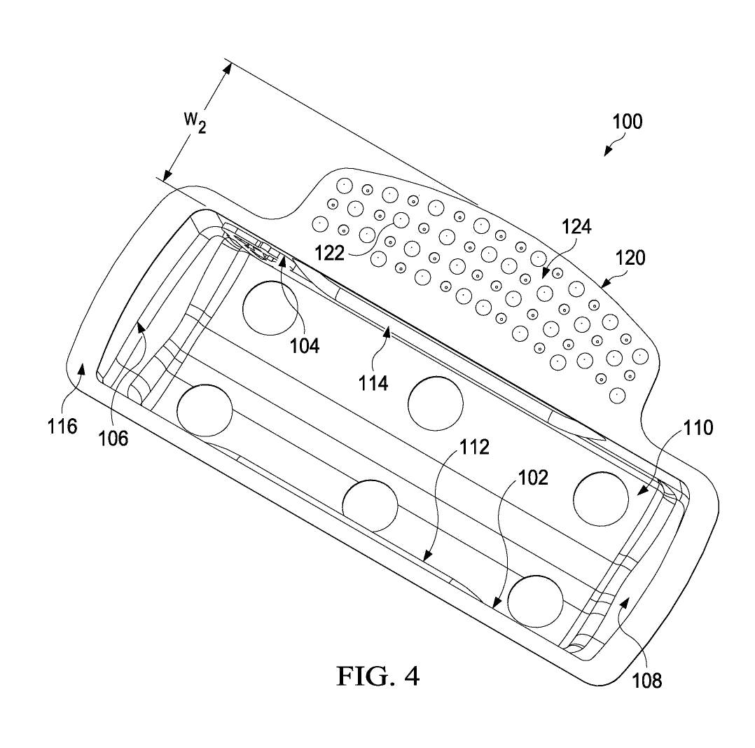

Referring to FIG. 4, another embodiment of a cover 100 is shown, which may be used to protect the shaving razor cartridge 20 of FIG. 2. In certain embodiments, the cover 100 may be injection molded or thermoformed from a polymer material, including, but not limited to poly vinyl chloride (PVC), polyethylene terephthalate (PET), high density polyethylene (HDPE), and low density polyethylene (LDPE), polypropylene (PP), or any combination thereof. The cover 100 may have a similar geometry and similar dimensions as the reversible cover 50, as previously described. For example, the reversible cover 100 may have a front wall 102, a back wall 104, and a pair of side walls 106 and 108 that define a pocket 110 dimensioned to nestingly receive the shaving razor cartridge 20 of FIG. 2. The front wall 102 and/or the back wall 104 may have one or more retention members 112 and 114 to secure the shaving razor cartridge 20 within the pocket 110, as previously described. A flange 116 may extend along the perimeter of the cover 100. The flange 116 may be joined transversely to the front wall 102, the back wall 104, and the pair of side walls 106 and 108. The cover 100 may be reversible and fit over the shaving razor cartridge 20, as previously described for the reversible cover 50. In other embodiments, the cover 100 may not be reversible and may fit on the shaving razor cartridge 20 in only a single position.

The cover 100 may differ from the cover 50 of FIG. 2 in that the flange 116 may have an enlarged tab member 120 associated with the back wall 104. The enlarged tab member 120 may provide an area of the flange 116 with an increased surface area for a consumer to grasp and remove the cover 100. In certain embodiments, the enlarged tab member 120 may have about 50%, 60%, or 70% to about 100%, 200%, or 300% greater surface area than an area of the flange 116 associated with an opposing wall (e.g., the front wall 102). In certain embodiments, the tab member 120 may have a width w₂ that extends out from the back wall 54, by about 1 mm, 2 mm, or 3 mm to about 5 mm, 10 mm, or 12 mm. The tab member 120 may also extend along about 30%, 40%, or 50% to about 60%, 80%, or 100% of the length of the back wall 104. The enlarged tab member 120 may also facilitate the disengagement of the retaining member 114 from the shaving razor cartridge 20 (e.g., lifting and or pulling the cover 100 away from the shaving razor cartridge 20) by providing more leverage to remove the reversible cover 50 from shaving razor cartridge 20. Although the enlarged tab member 120 of the flange 116 is shown associated with the back wall 104, the enlarged tab member may be associated with the front wall 102 and/or the side walls 106 and 108. The enlarged tab member 120 may be associated with only one wall, which may lessen consumer confusion as to where to grab the flange 116 to remove the cover 100.

The enlarged tab member 120 may have one or more removal indicia 122 (e.g., touch sensory elements) disposed on a top (not shown) and/or a bottom surface 124 of the tab member 120, to indicate a gripping surface to a user for removal of the reversible cover 100. The user would thus be inclined to remove the cover 100 by grasping the enlarged tab member 120. A touch sensory element in the present invention may be any item or element depending on the sense of touch. Such items may include the hand, finger, etc., coming into contact with or feeling something on an exterior surface and/or the sense perceived by that contact. The removal indicia 122 of the present invention may be any type of protrusion or recess effective at communicating a gripping and removal area to a user. For instance, the touch sensory elements 122 may include a plurality of protrusions and/or dimples; however the touch sensory elements 122 are not limited circular members.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” In an effort to avoid any ambiguity, for the purposes of this disclosure, the term “portion” shall be construed as meaning less than about 45%. For example, the term “distal end portion” should be interpreted as from about 0%, 5%, 10%, or 15% to about 15%, 20%, 25%, 30%, 40%, or 45% from the terminal end of the element referenced. Similarly, the term “proximal end portion” should be interpreted as from about 0%, 5%, 10%, or 15% to about 15%, 20%, 25%, 30%, 40%, or 45% from the end opposite the terminal end of the element referenced.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cartridge cover assembly comprising:
a shaving razor cartridge having least one blade, a top surface having a front end portion with a guard member and a rear end portion with a lubricating strip; and
a reversible cover having a front wall with a first retention member, a back wall with a second retention member, a bottom wall and a pair of side walls that define a pocket dimensioned to nestingly receive the shaving razor cartridge in a first position wherein the rear end portion of the shaving razor cartridge is engaged between the first retention member and the front wall of the reversible cover, and a second position wherein the rear end portion of the shaving razor cartridge is engaged between the second retention member and the back wall of the reversible cover, wherein the top surface of the shaving razor cartridge is spaced apart from the bottom wall of the reversible cover in both the first and second positions.

2. The cartridge cover assembly of claim 1 wherein at least one of the first and second retention members is an elongated protrusion.

3. The cartridge cover assembly of claim 1 wherein at least one of the front wall and back wall of the reversible cover has an elongated recess.

4. The cartridge cover assembly of claim 1 wherein the bottom wall of the cover has a first set of drainage openings.

5. The cartridge cover assembly of claim 4 wherein the bottom wall of the cover has a second set of drainage openings.

6. The cartridge cover assembly of claim 5 wherein the first and second set of drainage openings are arranged in parallel rows.

7. The cartridge cover assembly of claim 5 wherein at least one set of drainage openings is located directly beneath the lubrication strip in both the first and second positions.

8. The cartridge cover assembly of claim 7 wherein the top surface of the shaving razor cartridge is spaced apart from the bottom wall of the cover in both the first and second positions by about 0.5 mm to about 3 mm.

9. The cartridge cover assembly of claim 1 wherein the reversible cover has a flange.

10. The cartridge cover assembly of claim 8 wherein the flange includes an enlarged tab member.

11. The cartridge cover assembly of claim 9 wherein the enlarged tab member is associated with the back wall of the reversible cover.

12. The cartridge cover assembly of claim 9 wherein the enlarged tab member includes a removal indicia.

13. The cartridge cover assembly of claim 8 wherein the flange has a pair of opposing curved portions.

14. A cover for a shaving razor cartridge comprising:
a front wall with a first retention member, a back wall with a second retention member, a bottom wall and a pair of side walls defining a pocket dimensioned to nestingly receive a shaving razor cartridge; and
a flange joined transversely to the front wall, the back wall, and the pair of side walls, wherein the flange has an enlarged tab member associated with the back wall.

15. The cover of claim 13 wherein the enlarged tab member includes a removal indicia.

16. The cover of claim 14 wherein the removal indicia includes a plurality of protrusions on a top surface of the enlarged tab member.

17. The cover of claim 14 wherein at least one of the first and second retention members is an elongated protrusion.

18. The cover of claim 17 wherein at least one of the front wall and back walls has an elongated recess.

19. The cover of claim 14 wherein the bottom wall has a first and second set of drainage openings.

20. The cover of claim 19 wherein the first and second set of drainage openings are arranged in parallel rows.
